(19) United States
(12) Patent Application Publication
(10) Pub. No.: US 2006/0004592 A1
(43) Pub. Date: Jan. 5, 2006

(54) CHANGING ROOM

(75) Inventor: Jonathan Faith, London (GB)

Correspondence Address: NOVAK DRUCE & QUIGG, LLP, 1300 EYE STREET NW, 400 EAST TOWER, WASHINGTON, DC, 20005, US

(73) Assignee: RETELLIGENCE LIMITED, Surrey (GB)

(21) Appl. No.: 10/907,639

(22) Filed: Apr. 8, 2005

(30) Foreign Application Priority Data
Oct. 8, 2002 (GB) 0223319.5

(51) Int. Cl. G06Q 99/00

(52) U.S. Cl. 705/1

(57) ABSTRACT

A changing room having; an input device for receiving the identity of an item of goods; a data store for storing the characteristics of a plurality of items of goods; a display located in the changing room; and a controller for receiving input from the input device, retrieving data from the data store and controlling the display.

### TECHNICAL FIELD

This invention relates to a method and a system for ordering items from inside a changing area.

### BACKGROUND OF INVENTION

Many high street stores, especially clothing retail outlets, provide customers with changing facilities that allow the customer to ‘try on’ items before they decide to purchase them. For many shoppers, being able to try on an item of clothing is essential before they can decide to purchase them. Therefore providing changing facilities in retail outlets is highly desirable.

When a shopper enters a shop such as a clothing outlet, the shopper first browses the items displayed on the shop floor. Different sizes of each style of clothing are normally displayed so that the shopper may select items in their size from the items displayed. Once the shopper has selected items that they are interested in purchasing they may then proceed to the changing area.

In order to keep track of the number of items entering the changing room there is normally a maximum number of items a shopper can take into the changing room, typically three. This restricts the range of sizes and styles a customer may take into the changing room at once. If the customer finds that the size or style of the item is not suitable, it is necessary for the customer to either leave the changing room, return the unsuitable items and return to the shop floor, or attract the attention of a shop assistant from inside the changing room to ask for assistance.

If the customer decides to return the unsuitable items and return to the shop floor, the customer may be discouraged from selecting new items to try on, especially if there is a queue for the changing facilities. The outlet therefore loses a sale. On the other hand if the customer decides to stay in the changing room and attract the attention of a shop assistant, during busy periods the customer may have trouble doing so. Also, requesting assistance from inside a changing room may compromise a shopper's privacy. This may lead to the customer again feeling discouraged and the outlet again suffering a lost sale.

There is therefore a need for a system for a customer to select items to try on which addresses the problem listed above.

According to the present invention there is provided a changing room as set out in the claims.

### BRIEF DESCRIPTION OF THE DRAWINGS

The present invention will now be described by way of example with reference to the accompanying drawings, in which:

FIG. 1 shows a plan view of a shop comprising a changing area in accordance with an embodiment of the present invention;

FIG. 2 shows a block diagram of an ordering system in accordance with an embodiment of the present invention;

FIG. 3 shows a touch screen in accordance with an embodiment of the present invention;

FIG. 4 shows a cross section of a touch screen;

FIG. 5 shows a wire arrangement used in a touch screen;

FIG. 6 shows a delivery arrangement in accordance with an embodiment of the present invention; and

FIG. 7 shows an alternative arrangement for a changing room.

### DETAILED DESCRIPTION

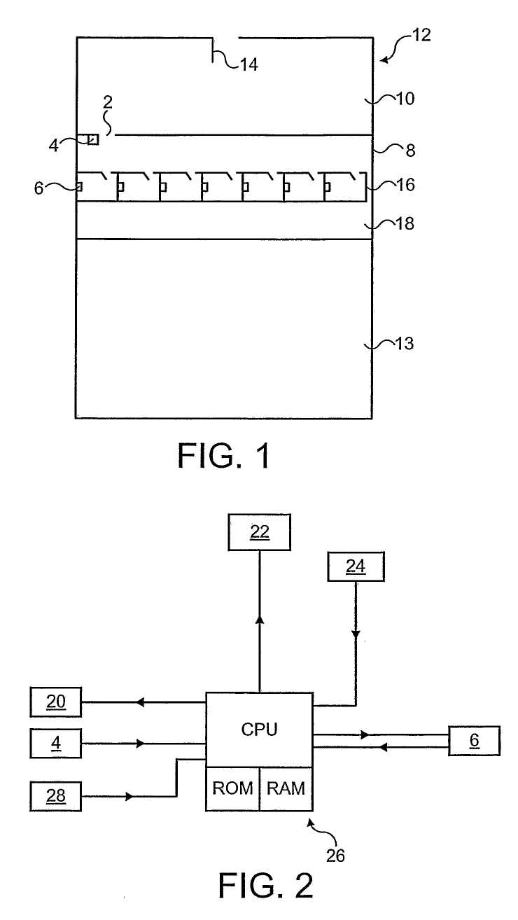

FIG. 1 is a diagram showing a shop 12 which includes a changing area 8 according to a first embodiment of the present invention. The shop 12 comprises a stock room 13, a shop floor 10, having an access 14 to the street and access 2 to the changing area 8. An item scanning device 4 is located at the access 2 between the changing area 8 and the shop floor 10. The item scanning device 4 may be wired to an ordering system 26 (described hereinafter) or wirelessly connected to the ordering system across, for example, an RF or IR link. The changing area comprises a plurality of changing rooms 16, each changing room having a touch screen 6 located inside. A service corridor 18 is optionally located behind the plurality of changing rooms 16.

FIG. 2 is a diagram showing an ordering system 26 in accordance with an embodiment of the invention. The scanning device and the touch screen have the same reference numerals in this figure as in FIG. 1. The scanning device and the touch screen are connected to a central processing unit (CPU) 100 having a read only memory (ROM) 102 and a random access memory (RAM) 104. The CPU is further connected to a ‘changing room number’ display 20, an ‘activity screen’ 21, a ‘customer order’ display 22 and a ‘stock room’ input means 24.

Referring to FIG. 1, the shop floor 10 is used to display a selection of the items on sale. Display stands (not shown) are commonly used in retail shops to present items to the shopper in a manner which allows the shopper to view different ranges of items as well as being able to select a certain type of item from a particular range. For example, in a clothes shop a selection of different styles of clothing may be presented on the shop floor in different sizes, allowing the shopper to select items in the style and size of their choice.

In a preferred embodiment of the invention, a tag or similar device for presenting information is attached to each item displayed on the shop floor 10.

The tag includes a bar code, or other machine readable tag, e. g. an RF tag, which contains information relating to the item. The tag may additionally display information relating to the item in typographical or pictorial form, so that the shopper may ascertain the size or other attributes of the item.

When the shopper has selected items that he wishes to try on, the shopper enters the changing area 8 via access 2. On entering the changing area the barcode on the tag of each item is scanned by a barcode reader of the item scanning device 4. The scanning device 4 forms part of the ordering system 26 shown in FIG. 2. Scanning the items may be performed either by a member of staff or by the shopper, however for reasons of security it is desirable for the items to be scanned by a member of staff.

Scanning the bar code on the tag of each item enters information relating to the item into the ordering system. This information is stored in the RAM 104 of the CPU 100. Information relating to the item which is read from the bar code may include the style of the item, the size and the color. If the item is an item of clothing, further information may also include the name of the designer for example DKNY or the range for example ‘petite’.

After the tags of each item selected by the shopper have been scanned, the user is then directed to a particular one of the plurality of changing rooms 16.

The shopper may be directed to a changing room by a shop assistant who is controlling the scanning device, or the shopper may decide for himself which changing room he wishes to enter. In either case it is necessary to input which changing room the shopper will be using into the ordering system.

Alternatively the ordering system may select which changing room the shopper should enter and may direct the shopper to that particular changing room by means of a display (not shown) arranged in the proximity of the scanning device 4. Alternatively the system 26 could direct a shopper to a changing room by printing a ticket that indicates the changing room that the shopper should use. The identification of the changing room is stored together with the information relating to the scanned items in the RAM 104 of the CPU 100.

A display and input means, such as a touch screen 6, is located inside each changing room, preferably at eye level on a wall of the changing room. The type of touch screen 6 with which an embodiment of the present invention is concerned is shown in FIG. 4. FIG. 4 shows a resistive touch screen system. There are other systems that are used to recognize a person's touch that are well known in the art and could be used in place of the resistive system. Such systems include the capacitive touch screen system and the surface acoustic wave touch screen system. However reference will only be made to the resistive touch screen system. The resistive touch screen system consists of a glass panel 200 overlying the cathode ray tube display (CRT) 150. The glass panel 200 is covered in a uniform resistive coating 300.

A thick polyester cover sheet 600 is suspended over the resistive coating 300, separated by small transparent insulating dots 500. The surface of the coversheet facing the glass panel 200 is covered in a conductive coating 400.

The opposite outer side of the coversheet 600 is covered in a scratch resistant coating 700.

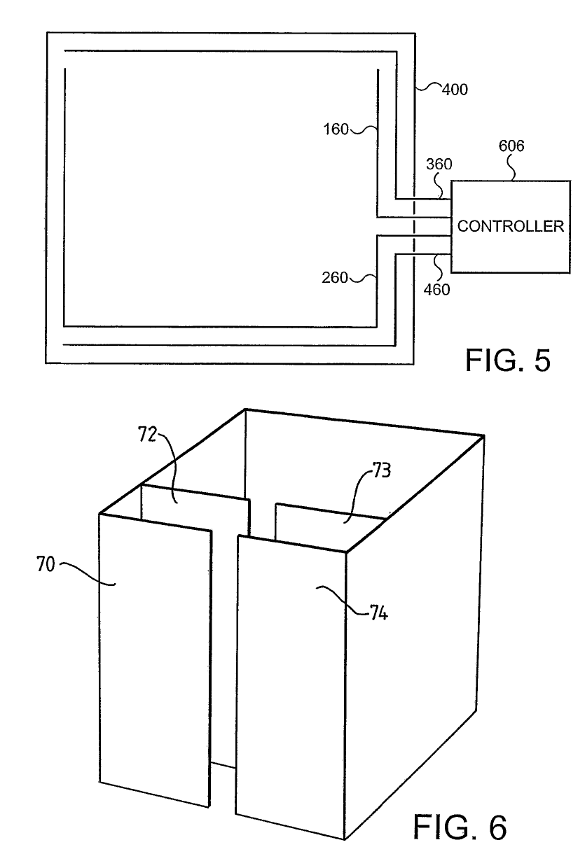

Four wires are arranged on the coversheet 600, over the conductive surface 400 as shown in FIG. 5. The resistive layer 300 is biased at +5V through four drive lines (not shown), and the coversheet is grounded through a high resistance. When the screen is touched the conductive coating 400 on the coversheet 600 is pushed against the resistive coating 300 on the glass panel 200, making electrical contact an electrical current runs through the conductive and resistive metallic layers. The voltage produced between the point of contact between the conductive layer 400 and resistive layer 300 and between the wires 160,260, 360 and 460 are detected by the controller.

Wires 160 and 260 detect the voltage produced by the touch along the x axis, whist wires 360 and 460 detect the voltage produced along the Y axis. The wires 160,260, 360 and 460 are connected to an analogue to digital converter (not shown) which forms part of the touch screen controller 606. The analogue to digital converter converts the voltages into a digital signal. The controller 606 translates the signal into x and y coordinates to be sent to the CPU 100.

The touch screen may serve as an interface to a number of services offered by the ordering system. The ‘welcome screen’ which is displayed on the touch screen to the shopper upon entering the changing room allows the user select a service from any of the services offered. In a preferred embodiment of the invention the information relating to the scanned items is stored in the RAM together with the identification of the changing room to which the shopper has been directed. This information is processed by the CPU and output to the touch screen inside the changing room to which the shopper has been directed, such that the welcome screen displays, typographically and/or pictorially a representation of the items scanned at the scanning device 4.

In an embodiment of the present invention the touch screen may be further connected to a DVD or video player (not shown). The touch screen may then be arranged to play advertisements or visual entertainment. The touch screen may be arranged to play information from the DVD or video player after if has been determined that the touch screen has not been touched for a predetermined time. The touch screen may be arranged to play an audio and/or video welcome message when a shopper arrives in the changing room.

Information relating to the items stocked by the shop are stored in the ROM of the CPU, or on a central database to which the CPU has access. This information may be stored in a variety of ways. In a preferred embodiment of the invention, this information may be stored in a series of look up tables.

Each look up table may store the identification of items relating to a particular attribute. For example, the styles of items having a particular color or size.

Alternatively or additionally, look up tables may store information relating to a particular type of item. This may include an indication of whether or not a particular item is in stock, or whether complementary items, such as matching accessories are available.

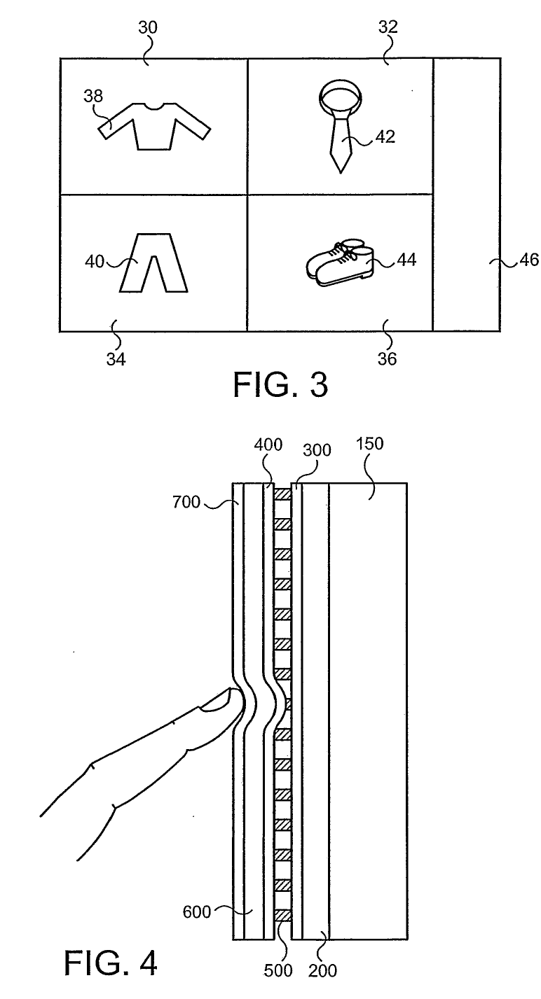

When the shopper is trying on items in the changing room, the user may access information stored in the ROM of the CPU by means of the touch screen interface. This information may be presented by the user in a number of ways. For example, FIG. 3 shows a touch screen display that may be presented to the shopper upon entering the changing room. This initial display may be referred to as a ‘welcome screen’. The display shows a pictorial representation of the items scanned in at the scanning device 4. A picture of a jumper 38 is displayed in the upper left hand quadrant 30 of the display, a picture of A TIE 42 is shown in the upper right hand quadrant 32 of the display, a picture of trousers 40 are shown in the lower left hand quadrant 34 of the display and a picture of a pair of shoes 44 are shown in the lower right hand quadrant 36 of the display.

Information relating to any of the items shown on the display is selectable by touching the region of the display in which the item is shown. Preferably the touch screen can be arranged to provide instructions to the user on how to use the system, including to touch a region of the display to obtain information on an item. For example the jumper is selectable by touching the upper left hand quadrant 30 of the display. When quadrant 30 is touched when the welcome screen shown in FIG. 3 is displayed, the controller 606 generates the coordinates of the position of the touch and sends them to the CPU 100.

The coordinates of the touch and the type of display, in this case the welcome screen, are used as variables for a program stored in the ROM which enables the shopper to navigate through the selection of screen options. Using the information derived from scanning the items, the program recognizes that the coordinates of the touch on the touch screen relate to a jumper of a particular style, size and color and coordinating items. By referring to the look up tables stored in the ROM, the program retrieves information relating to alternative sizes, colors or styles of the jumper. This information may be presented to the shopper at once by displaying the information together, or by allowing the shopper to specify what information he wishes to see by presenting different options on the touch screen.

The shopper may touch a region of the screen to have such items displayed, and to touch the screen again to go back to the former display. The system may also present the shopper with a tabbed window display, including information on other aspects of a product, including, for example, comments from the product's designer.

If the shopper wishes to try on an item which is displayed as an alternative to the item which he has in the changing room, the shopper may order the item by selecting the item and a desired size thereof using the touch screen. On receipt of an order request, the CPU relays the request to the stock room display 22. The display shows a representation of the ordered item, together with the source of the request, i.e. the identification of the particular changing room.

In an alternative embodiment of the present invention a further screen may be provided in each changing room. This screen will be hereinafter referred to as an activity screen 81 and is shown in FIG. 8. The purpose of the activity screen is to show the shopper what he or she has in the changing room in as well as what he or she has ordered using the touch screen. In an embodiment of the invention the activity screen is divided into three main sections: a first section 82 lists either pictorially or typographically, the items that the shopper has in the changing room and/or has ordered; the second section 83 indicates whether the item listed in section 81 is presently in the changing room, whether the item has been ordered but has not yet arrived, or whether the ordered item has been delivered ; finally the third section 84 indicates the price of the items shown in section 82. Section 84 may further display the total price of the items that the shopper has in the changing room and/or has ordered.

In a preferred embodiment of the present invention the activity screen measures 14″×14″ and the touch screen measures 21″×21″.

Staff located in the stockroom 13 responds to orders shown on the stockroom display 22 as soon as a request is received, by either retrieving the item from the stockroom or the shop floor, or by responding to the shopper via stockroom input means 24. The staff on the shop floor may alternatively be provided with wireless terminals that can display the order. If the item has sold out, a member of staff in the stockroom may indicate this to the shopper by inputting a message into the stockroom input means 24. This message is relayed to the touch screen from which the request was made via the CPU. Alternatively, the stockroom input means may be used to input information indicating that an item has sold out as soon as a member of staff is aware of that the item has sold out. In an alternative embodiment of the present invention the CPU 100 may be connected to a database (not shown) that stores a real time indication of the stock in the store. Stock levels stored on the database may be incremented after a delivery of a particular item and decremented after a sale. This information may be stored in the RAM of the CPU so that a message may be generated by the CPU in reply to a request for an item that has sold out.

If the item is available, a member of staff can deliver the item to the shopper in his/her changing room. This may be achieved in a manner which allows the member of staff to pass the item into the changing room without compromising the shopper's privacy. FIG. 6 shows an arrangement in accordance with an embodiment of the present invention for delivering items into the changing room. The entrance 70 to the changing room, through which the shopper enters is concealed by two sets of doors, comprising an inner set 72 and an outer set 74. The shopper enters the changing room by opening both sets of doors.

When the member of staff wishes to deliver an item to the changing room the member of staff may deliver the items by opening the outer doors only and depositing the item between the doors. For example the item may be hung on a hook which protrudes from the surface of the inner door which faces the outer set of doors. Once the item has been delivered by the member of staff and the outer doors to the changing room have been closed, the member of staff may indicate to the shopper that the item has been delivered by activating an indicator such as a buzzer or a light or a message on the touch screen 6. Alternatively a voice message may be played to the shopper announcing that the item (s) have arrived. A switch is preferably provided outside and adjacent to the changing room whereby the member of staff may activate the indicator. The shopper may then open the inner doors to retrieve the item. A switch may be provided inside the changing room whereby the indicator may be cancelled by the shopper; alternatively the program that is executed by the CPU may be arranged so that the shopper can cancel the indicator by means of the touch screen, or the indicator may be deactivated after a predetermined time.

In a preferred embodiment of the present invention the CPU will be arranged to indicate to the activity screen that the ordered item has been delivered. The activity screen may then change the displayed status of the item accordingly.

In an embodiment of the present invention, a further bar code scanner may be provided in the proximity of the changing room. This would allow the data relating to the delivered items to be captured and input to the ROM of the CPU. The information may then be presented to the shopper on the touch screen. If the further bar code scanner is placed by the delivery entrance to the changing room, the member of staff may scan the delivered items before placing them inside the outer set of doors as described above. Alternatively, the further bar code scanner may be placed inside the changing room so that the shopper may scan the delivered items himself.

In an alternative embodiment of the present invention the member of staff who delivers and removes items from the changing room may be provided with a terminal that incorporates a scanner for scanning the barcode on the items. When items are delivered to, or removed from, a changing room the member of staff can scan the item to indicate to a central database that a particular item has either been delivered or removed from a particular changing room.

In addition to providing an arrangement for delivering items, the doors may also function as an arrangement for returning unwanted items to prevent the changing room from becoming cluttered with items. This may be achieved by the member of staff collecting all items which are left in between the inner and outer doors when the items are being delivered. A window may be provided on an outer door 74, so that a member of staff may see when unwanted items are ready for collection. Alternatively, a member of staff may intermittently check in between the doors for returned items. The returned items may be distinguished from delivered items which have not yet been collected by the shopper by hanging returned items on a separate hook to delivered items. To allow this to be done, two zones for receiving articles may be provided between the doors. One zone is intended for receiving delivered items and one zone is intended for receiving returned items. Each zone may be identified by a sign at the zone. Each zone may have one or more hooks, shelves or other receptacles for receiving items.

In an alternative embodiment of the present invention the shopper and the members of staff may distinguish between items that have been delivered to the changing room and items that are to be returned by using different colored hangers. For example, items that have been delivered to the changing room may be placed on green hangers and items that are to be collected from the changing room may be placed on red hangers.

In an alternative embodiment of the present invention the shopper may place unwanted items on a hook which makes electrical contact with a switch. The switch may activate an indicator that indicates to members of staff that there are unwanted items in the changing room that are ready for collection. When the member of staff retrieves the items from the hook, electrical contact with the switch is broken and the indicator is deactivated.

In an embodiment of the present invention the member of staff may scan each item that they collect from the changing room in order to indicate to the activity screen and the shopper that the item is no longer in the changing room.

By recording the items that are taken into and collected from each changing room, using methods such as those described above, the retailer may be provided with information on how many items are in a changing room at a particular time. This may assist security procedures in the shop. For example, in an embodiment of the present invention, on exiting the changing room the shopper may be asked to take all the remaining clothes from the changing room and asked which items they wish to purchase and which items they wish to return. If the amount of items taken from the changing room by the shopper do not tally with the information provided by the ordering system relating to the number of clothes in the changing room, the situation may be investigated further.

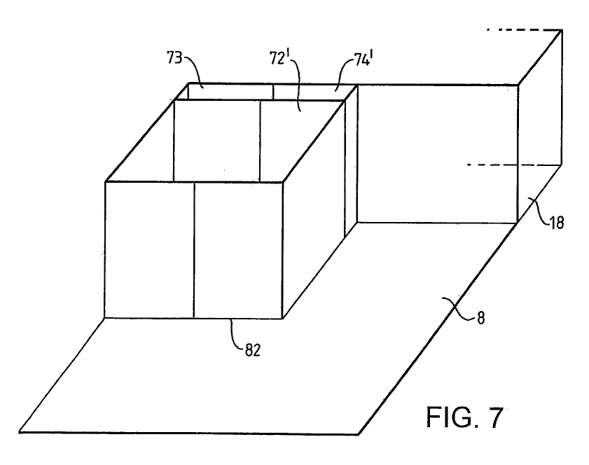

An alternative arrangement to the delivery system shown in FIG. 6 is shown in FIG. 7. In this arrangement the shopper enters the changing room through a single set of doors 82 which are arranged to provide access to the changing room from the changing room area 8. The delivery arrangement comprising an inner set of doors 72′ and an outer set of doors 74′ is arranged to provide a separate access to the changing room from the service corridor 18. In FIG. 7 the delivery arrangement is on the opposite side of the changing room to the single set of doors 82. Delivery of items through the delivery arrangement occurs in the same manner as described in relation to FIG. 6.

Providing a delivery access arranged between the changing room and the service corridor allows a member of staff to deliver the ordered item to the shopper without having to enter the changing area. This allows the items to be transferred to the changing room more efficiently.

In the arrangements shown in FIGS. 6 and 7 there is a vestibule 73 between the inner and outer doors 72/72′ and 74/74′. Since it is expected that a member of staff may access the vestibule to bring or take items of clothing, it is preferred that means are provided to prevent both the inner and outer doors from being opened simultaneously whilst a shopper is in the changing room. Such means could be mechanical (for example a latch operable from inside the changing room) or electrical (for example an electromagnetic or electromechanical interlock system operable by a switch in the changing room). Nevertheless, in most instances it will be most convenient for the shopper to open both the inner and outer doors on leaving the changing room.

In a further embodiment of the present invention, information processed by the ordering system such as the number of changing rooms occupied at a given time may be used by the retailer to determine the proportion of time the changing rooms are occupied for. This information may help the retailer to determine whether the number of changing rooms provided in a particular retail outlet are sufficient.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

What is claimed is:

1. A changing room having; an input device for receiving the identity of an item of goods; a data store for storing the characteristics of a plurality of items of goods; a display located in the changing room; and a controller for receiving input from the input device, retrieving data from the data store and controlling the display.

2. A changing room according to claim 1, further comprising: a first opening through which a shopper may enter the changing room; and a second opening whereby goods may be delivered into the changing room; and a delivery arrangement located at the second opening and having a first configuration in which it can receive goods from the exterior of the changing room, and a second configuration in which goods received in the arrangement are accessible from the interior of the changing room.

3. A changing room as claimed in claim 1, wherein the controller is arranged to retrieve from the store a characteristic of the item of goods, and cause it to be displayed on the display.

4. A changing room as claimed in claim 3, wherein the said characteristic is physical appearance.

5. A changing room as claimed in any of claims 1 to 4, wherein the controller is arranged to search the store for goods having at least one characteristic in common with the item of goods and at least one characteristic not in common with the item of goods, to retrieve a characteristic of each of those items and cause it to be displayed on the display.

6. A changing room as claimed in claim 5, wherein the said characteristics include two or more of size, color and style.

7. A changing room according to any preceding claim, further comprising a selection means whereby an occupant of the changing room may select a characteristic of goods.

8. A changing room according to claim 7, wherein the selection means and the display are provided by a touch screen.

9. A changing room as claimed in claim 7 or 8, wherein the said characteristic is one of a plurality of characteristics displayed on the display.

10. A changing room as claimed in any of claims 7 to 9 as dependent on claim 5 or 6, wherein the selected characteristic is the characteristic not in common.

11. A changing room according to any of claims 7 to 10, comprising further selection means for selecting an option to order an item having the selected characteristics.

12. A changing room as claimed in claim 11, wherein the controller is adapted to, in response to the selection of the option to order an item, issue a command for the delivery of the item to the changing room.

13. A changing room as claimed in claim 12, wherein the delivery arrangement comprises a second input device linked to the controller, and the controller is arranged to, in response to operation of the second input device, cause the display to indicate the availability of an item of goods in the delivery arrangement.

14. A changing room according to any preceding claim, wherein said input device comprises a scanning device.

15. A changing room according to claim 14, wherein said input device comprises a bar code scanning device.

16. A changing room as claimed in any preceding claim, wherein the delivery arrangement is arranged to obscure the second opening in the first and second configurations.

17. A changing room according to any preceding claim, wherein the delivery arrangement comprises a space and a first door located between the space and the interior of the changing room and a second door located between the space and the exterior of the changing room.

18. A changing room as claimed in claim 17, wherein there is a first zone in the space for receiving items for delivery to the interior of the changing room and a second zone in the space for receiving items for expulsion from the changing room.

19. A changing room as claimed in claim 18, wherein there is a first hook for receiving items at the first zone and a second hook for receiving items at the second zone, each of the first and second hooks being mounted to one of the first and second doors.

20. A changing room as claimed in any of claims 17 to 19, wherein both of the first and second doors are non-transparent.
